(19) United States
(12) Patent Application Publication
(10) Pub. No.: US 2022/0000285 A1
(43) Pub. Date: Jan. 6, 2022

(54) Illumination System and Lamp

(71) Applicants: Wanjiong Lin, Ningbo (CN); Self Electronics Co., Ltd., Ningbo (CN); Self Electronics USA Corporation, Norcross, GA (US)

(72) Inventors: Yuanfang Xue, NINGBO (CN); Huangfeng Pan, NINGBO (CN); Junjun Ying, NINGBO (CN)

(73) Assignees: Wanjiong Lin; Self Electronics Co., Ltd.; Self Electronics USA Corporation

(21) Appl. No.: 17/305,315

(22) Filed: Jul. 2, 2021

(30) Foreign Application Priority Data
Jul. 1, 2020 (CN) 202010622733.4

(51) Int. Cl. A47F 11/10; A47F 3/00; F21V 14/02; F21V 33/00; F21V 23/00

(52) U.S. Cl. CPC A47F 11/10; A47F 3/001; F21V 23/004; F21V 33/0012; F21V 14/02

(57) ABSTRACT

An illumination system has a display area and a main light source arranged above the display area, and an auxiliary light source arranged above the display area. The illumination system and the lamp through the visual optical superposition principle, provides brightness lighting by the main light source and provides different quantities of auxiliary light sources to flicker the subject. Consumers gain a better shopping experience as the gradient of the light changes so smoothly as to be imperceptible.

### RELATED APPLICATION

This application claims priority to a Chinese Patent Application No. CN 202010622733.4, filed on Jul. 1, 2020.

### FIELD OF THE TECHNOLOGY

The present embodiments relates to the field of lighting techniques, in particular a illumination system and lamp.

### BACKGROUND

In the context of energy-saving and environmentally friendly, LED lamps have become more applicable to home, commercial lighting fields due to high lighting efficiency and good concentration performance.

In commercial lighting, for jewelry and other valuables, the shining degree is a key factor in determining its value. At present, this type of lighting product on the market is mostly increasing the visual effect of such products by increasing light intensity, increasing the shade of shading, and so on ways to increase the visual effect of this kind of product to improve its ornamental value, in turn, promote sales price, but this kind of method not only can increase the energy consumption and has higher requirements on site.

In order to solve the above problems, it is necessary to propose a illumination system that can effectively improve the lighting effect on the product, while the energy consumption and environment have no special requirements.

### BRIEF SUMMARY

In view of this, the present embodiments provides a illumination system to solve the above technical problems.

An illumination system includes a display area, and a main light source arranged above the display area; a light outlet direction of the main light source is directed towards the display area and a first illumination surface is formed on the display area; it also includes an auxiliary light source arranged above the display area, and a light outlet direction of the auxiliary light source is toward the display area and a second illumination surface is formed on the display area, and the second illumination surface moves within the first illumination surface and the ratio of a luminance value of the second illumination surface to a luminance value of the first illumination surface is less than C, wherein C is a limit value of human eyes perceived brightness change.

Wherein, C is the limit value of the perception of brightness changes, which refers to the boundary value for human eyes to observe light changes. That is, when the brightness ratio exceeds C, human eyes can notice that the light is changed, and when the brightness ratio is below C, human eyes cannot notice light changes. In addition, as the second illumination surface moves within the first illumination surface, the products such as jewelry, etc. with multiple reflective surfaces or cutting surfaces placed within the first illumination surface, the light reflected to human eyes changes, which will bring the flickering effect and increase the visual experience, and increase the user's desire to buy.

A plurality of main light source can be set to form the first illumination surface (background light) so that the movement of the second illumination surface is undetectable. In summary, the embodiments provide an auxiliary light source that generates a moving second illumination surface, and the movement of the second illumination surface will not be detected due to the first illumination surface (background light), and the movement of the second illumination surface will bring a flickering effect to the jewelry with a cutting surface and a reflecting surface.

Advantageously, the auxiliary light source is provided with a plurality.

Advantageously, the auxiliary light source is arranged around the main light source.

Advantageously, the auxiliary light source is able to movable, swing or rotation.

Advantageously, The illumination system further includes a mounting plate arranged directly above the display area, and the main light source and auxiliary light source are arranged on the mounting plate.

Advantageously, the mounting plate is provided with a moving passage, and the auxiliary light source is arranged in the moving passage.

Advantageously, the moving passage is a ring arranged about the main light source.

Advantageously, the mounting plate is provided with a lamp holder, and the main light source and auxiliary light source are set in the same lamp holder.

Advantageously, the illumination system further includes an anti-glare layer arranged above the display area, and the main light source and the auxiliary light source (300) are located above the anti-glare layer.

A lamp includes a lamp holder and a main light source arranged in the lamp holder, and a light direction of the main light source is toward the object to be irradiated and a first illumination surface is formed on the display area where the object is irradiated, and it further includes a movable mechanism arranged in the lamp holder and an auxiliary light source arranged on a power output end of the movable mechanism, and a light outlet direction of the auxiliary light source is toward the display area and a second illumination surface is formed on the display area, and the second illumination surface moves within the first illumination surface and a ratio of a luminance value of the second illumination surface to a luminance value of the first illumination surface is less than C, wherein C is a limit value of human eyes perceived brightness change.

Advantageously, the movable mechanism is a rotating mechanism, which comprises a fixing seat, a rotating seat rotatable arranged on the fixing seat, and a power source arranged on the fixing seat to drive the rotating seat, and the rotating seat has a center axis.

Advantageously, the rotating seat is provided with a driving circuit board which is electrically connected with power supply equipment, and a plane where the driving circuit board is located is perpendicular to the rotation center axis, and the auxiliary light source is arranged on the driving circuit board and deviates from the rotation center axis.

Advantageously, the main light source is arranged in the lamp holder.

Advantageously, the main light source is arranged on the driving circuit board and its maximum light intensity direction is coincident with the rotation center shaft.

Advantageously, the fixing seat and the lamp holder are separately arranged and a shock absorbing layer is provided between the two.

The technical effects of the present embodiments:

The illumination system and the lamp of the present embodiments, through visual optical superposition principle, provides brightness lighting by the main light source and provides different quantities of auxiliary light sources to flicker the subject. It can make consumers cannot perceive changes in the light, so as to give consumers a better shopping experience.

### BRIEF DESCRIPTION OF THE DRAWINGS

Embodiments of the present embodiments will be described below with reference to the drawings, in which:

FIG. 1 is a structural diagram of a illumination system for one embodiment of the present embodiment.

FIG. 2 is a reference diagram of the recognition ability of human eyes to brightness changes.

FIG. 3 is a perspective view of the illumination system in FIG. 1.

FIG. 4 is a light effect diagram of the illumination system and lamp of the present embodiment is shown in the display area.

FIG. 5 is a structural diagram of an illumination system for another embodiment.

FIG. 6 is a perspective view of the illumination system in FIG. 6.

FIG. 7 is a structural diagram of an illumination system for another embodiment.

FIG. 8 is a perspective view of the illumination system of the embodiment in FIG. 7.

FIG. 9 is a structural diagram of an illumination system for another embodiment.

FIG. 10 is a cross-sectional view of the illumination system in FIG. 9.

FIG. 11 is an exploded schematic of the illumination system in FIG. 9.

### DETAILED DESCRIPTION

Specific embodiments of the present embodiments will be further described below based on the drawings. It should be understood that the description of the embodiments of the present embodiments is not intended to limit the scope of the embodiments.

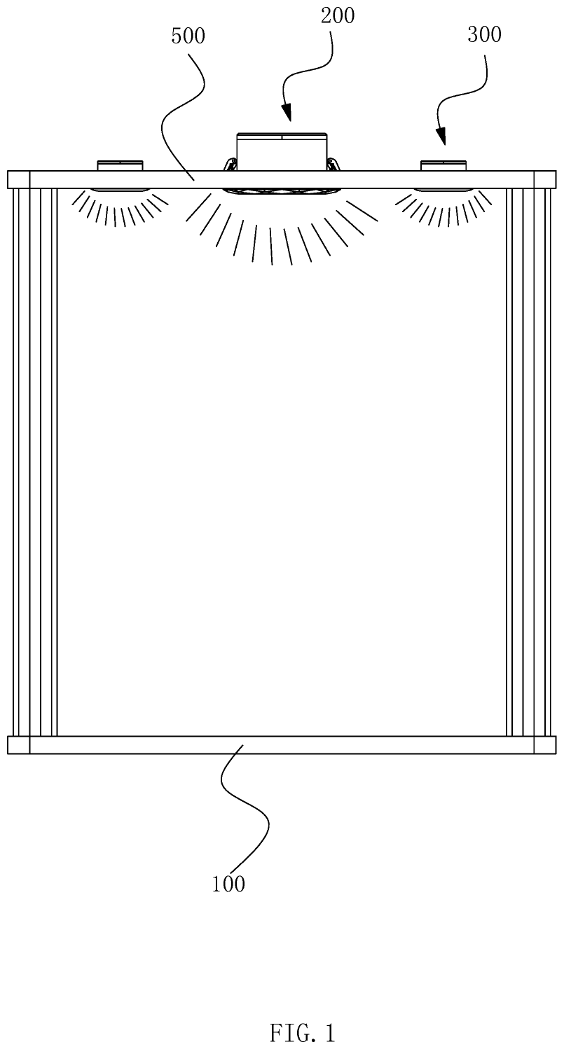

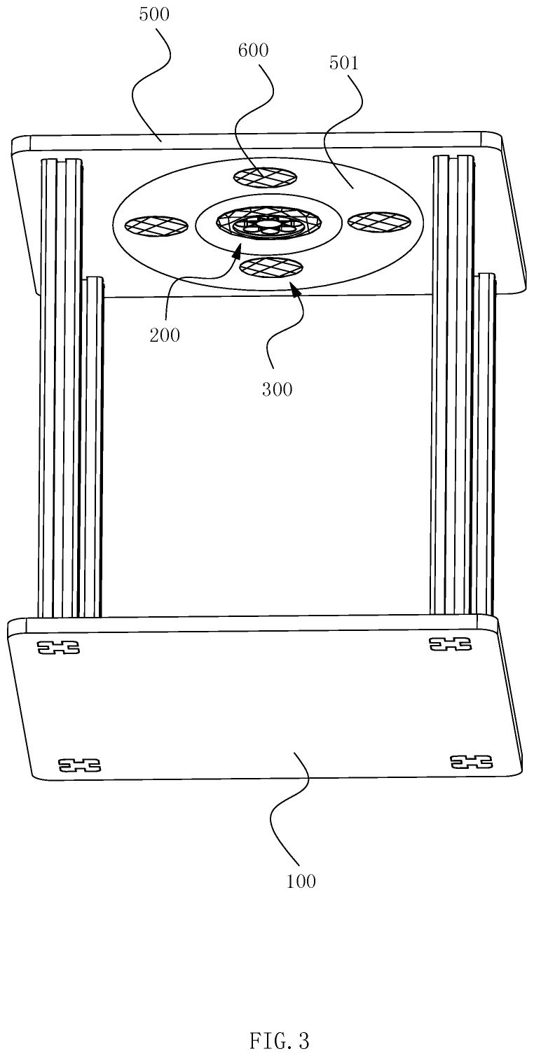

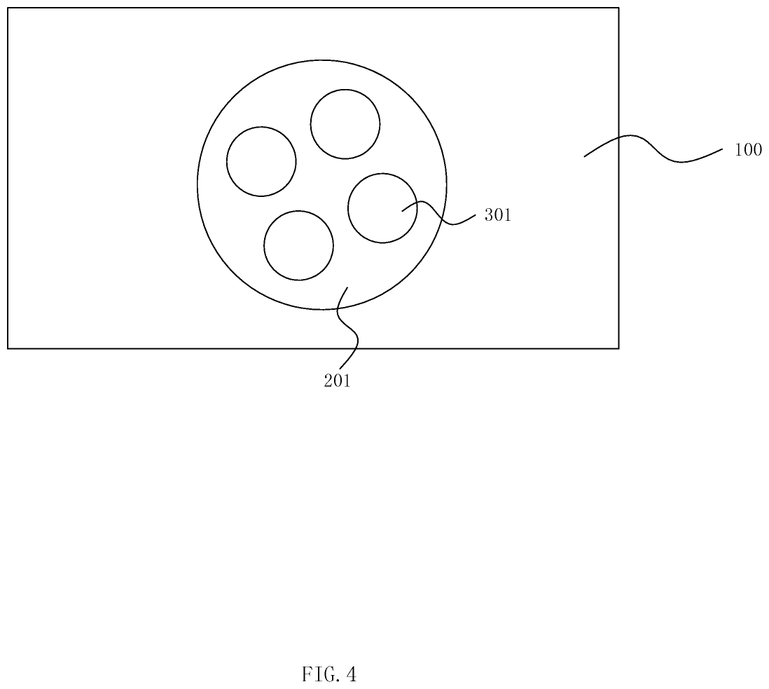

As shown in FIG. 1-4, the illumination system of the present embodiment includes a display area 100, and a main light source 200 arranged above the display area 100. The light outlet direction of the main light source 200 is directed towards the display area 100 and a first illumination surface 201 is formed on the display area 100. It also includes an auxiliary light source 300 arranged above the display area 100. The light outlet direction of the auxiliary light source 300 is toward the display area 100 and a second illumination surface 301 is formed on the display area 100. The second illumination surface 301 moves within the first illumination surface 201 and the ratio of the luminance value of the second illumination surface 301 to the luminance value of the first illumination surface 201 is less than C, where C is the limit value of the perceived brightness change. Wherein, C is the limit value of the perception of brightness changes, which refers to the boundary value for human eyes to observe light changes. That is, when the brightness ratio exceeds C, human eyes can notice that the light is changed, and when the brightness ratio is below C, human eyes cannot notice light changes. In addition, as the second illumination surface 301 moves within the first illumination surface 201, the products such as jewelry, etc. with multiple reflective surfaces or cutting surfaces placed within the first illumination surface 201, the light reflected to human eyes changes, which will bring the flickering effect and increase the visual experience, and increase the user's desire to buy.

The display area 100 is the bottom surface of the platform in the figures, or the top surface of the display platform added to the platform. In short, it is the position where the items to be displayed are placed.

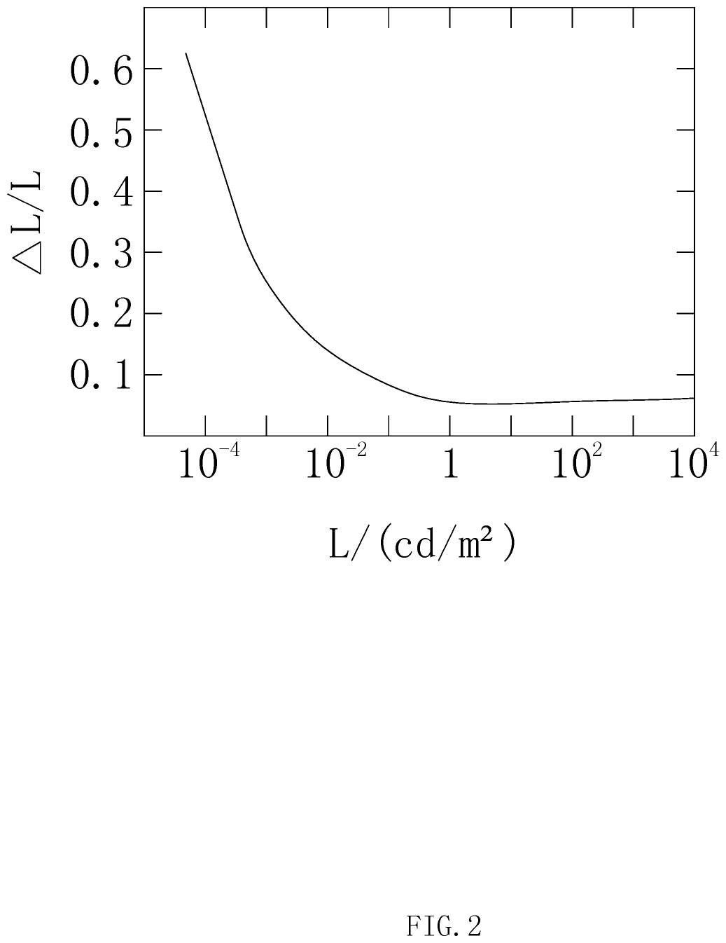

C value has different values when the brightness of the first illumination surface 201 is different, as shown in FIG. 2. Specifically, when the beam angle of the main light source 200 is 30°, if the brightness value L at the most edge of the first illumination surface 201 is about 1000 cd/m², L is the brightness value at the lowest brightness of the first illumination surface 201, and the brightness value is the background brightness. According to FIG. 2, when the longitudinal axis C=ΔL/L is less than 5%, ΔL is the maximum brightness value in the moving second illumination plane 301, and the human eye cannot distinguish the illumination difference, that is, when lamps with different luminance are irradiated in the same area at the same time, and ΔL/L is less than 5%, even if the light source is rotating, moving or swinging, the human eye cannot be perceived the change of light and shade.

When the distance between the display area 100 and the main light source 200 and the auxiliary light source 300 is determined, the illumination formed on it is determined. By adjusting the distance between the main light source 200 and the auxiliary light source 300 and the display area 100 as well as the intensity of their respective light, the main light source 200 and the auxiliary light source 300 that meet the requirements can be obtained.

The determination of the first illumination surface 201 and the second illumination surface 301 is related to the beam angle, and the size of the beam angle is related to the optical element through which the light source passes. This is the prior art, which will not be described here. Generally, in the illumination surface of a light source, the edge of the illumination surface has the lowest brightness.

In order to further increase the flicker effect, the auxiliary light source 300 is provided with a plurality. If the second illumination surface 301 of 300 of several auxiliary light sources is superimposed, ΔL becomes the maximum brightness value after superposition.

There are many ways to realize the movement of the second illumination surface 301, which can be realized by the movement, swing or rotation of the auxiliary light source 300. It can use the control program to control the motion trajectory of the auxiliary light source 300 and the speed to get the desired flicker effect. In this embodiment, the auxiliary light source 300 is set around the main light source 200 for the purpose of centralized illumination.

In the embodiments, the illumination system also includes a mounting plate 500 arranged directly above the display area 100. The main light source 200 and the auxiliary light source 300 are arranged on the mounting plate 500, and the setting of the mounting plate 500 improves the integrity.

In the embodiments, the main light source 200 and the auxiliary light source 300 adopt an LED chip. The LED chip has the advantages of small volume and energy saving. Other forms of light sources can also be used and it will not repeat here.

When the auxiliary light source 300 rotates or swings in place, the effect of moving the second illumination surface 301 can be achieved. In order to increase the amplitude, the moving passage 501 is arranged on the mounting plate 500 in this embodiment, and the auxiliary light source 300 is arranged in the moving passage 501. The moving passage 501 is a ring arranged around the main light source 200. How to realize the movement of light source in the moving passage 501 is the prior art, and the driving structure can be set up, which will not be described here. It also includes a anti-glare layer 600 arranged above the display area 100, and the main light source 200 and the auxiliary light source 300 are located above the anti-glare layer 600.

The anti-glare layer 600 can be set individually for each light source, or it can be an integral to block the moving passage 501 or mounting plate 500. The specific principle is to make the light source and the light emitting surface have a certain distance, so that the personnel is not easy to see the light source itself, to prevent glare. In this embodiment, each auxiliary light source 300 is provided with an anti-glare layer 600 located in its outlet direction, which can move along with the auxiliary light source 300.

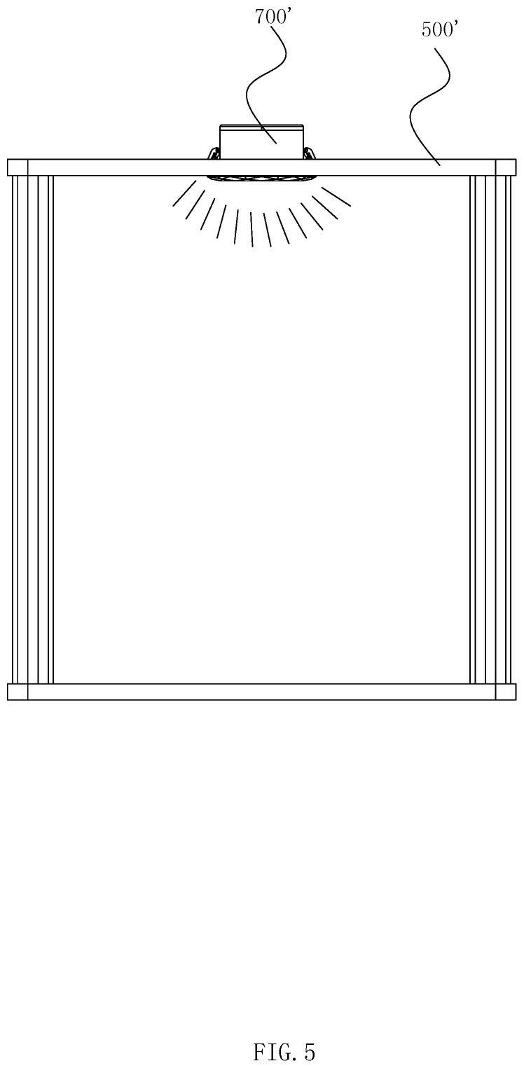

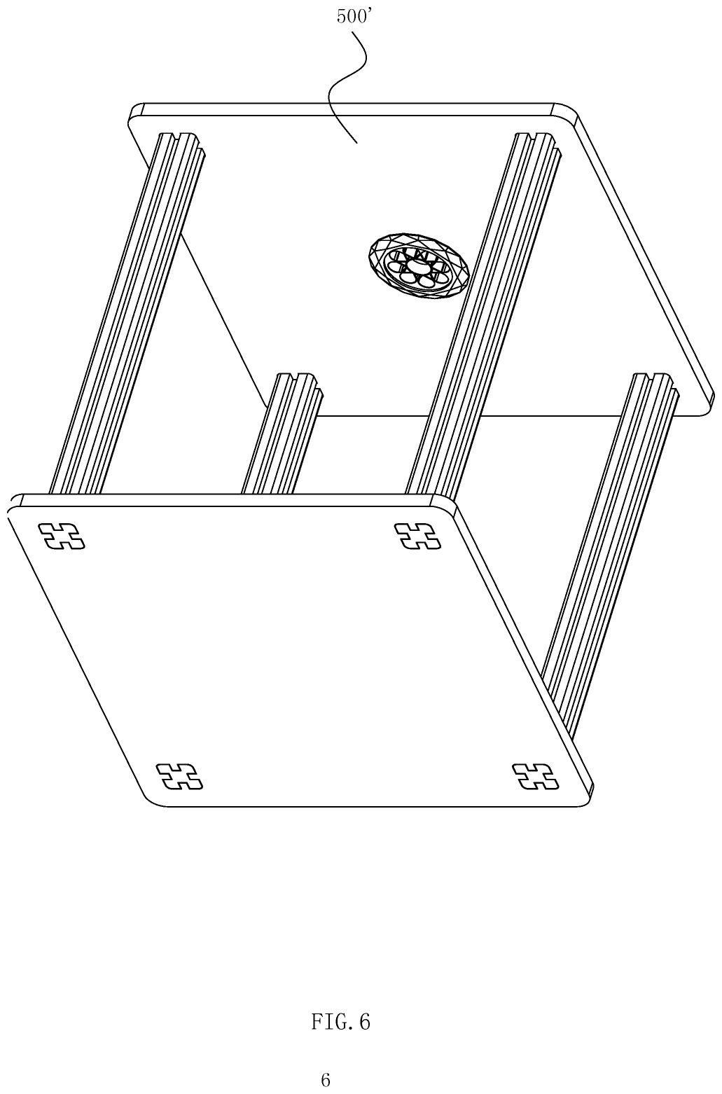

As shown in FIG. 5-6, in another embodiment, the mounting plate 500′ is provided with a lamp holder 700′. The main light source (located in the lamp holder 700, not shown in figures) and auxiliary light source (located in the lamp holder 700, not shown in figures) is set in the same lamp holder 700′, which further improves integrity.

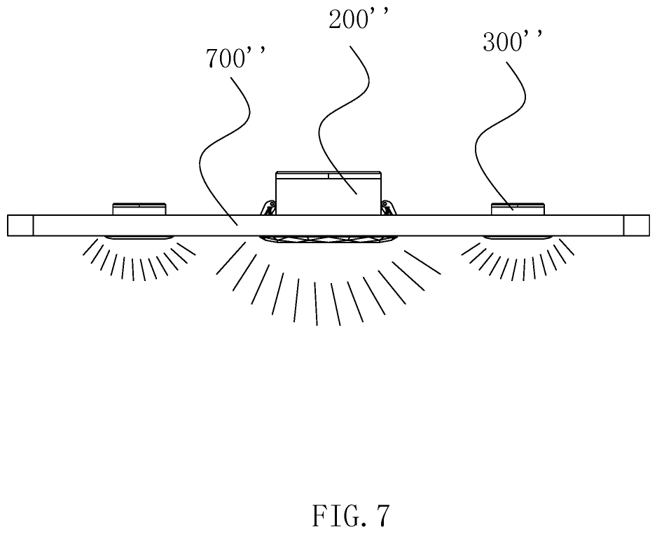

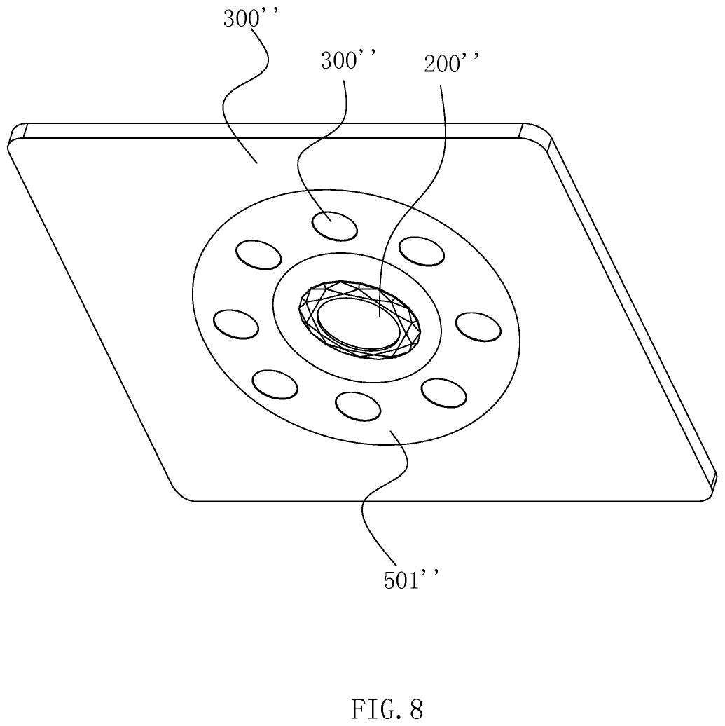

As shown in FIG. 7-8, in another embodiment, the lamp includes a lamp holder 700″ and a main light source 200″ arranged in the lamp holder 700″. The light direction of the main light source 200″ is toward the object to be irradiated and a first illumination surface 201 is formed on the display area 100 where the object is irradiated. And it further includes a movable mechanism 800″ arranged in the lamp holder 700″ and an auxiliary light source 300″ arranged on the power output end of the movable mechanism 800″. The light direction of the auxiliary light source 300″ is toward the display area 100 and a second illumination surface 301 is formed on the display area 100. The second illumination surface 301 moves within the first illumination surface 201 and the ratio of the luminance value of the second illumination surface 301 to the luminance value of the first illumination surface 201 is less than C, where C is the limit value of the perceived brightness change.

The lamp holder 700″ of the present embodiment is a plate, but its form is not limited, and the lamp holder 700″ is used to carry the light source. The lamp holder 700 is provided with a moving passage 501″, the auxiliary light source 300″ is set on the moving passage 501″. The moving passage 501″ is a ring that surrounds the main light source 200″. How to achieve the movement of the light source in the moving passage 501 is the prior art, the driving structure is needed to set, and details will not be described here. The main light source 200″ is fixed in the lamp holder 700″.

The movable mechanism 800″ can be a rotation mechanism, a moving mechanism, or a swing mechanism, and the movement of the second illumination surface 301 can be achieved.

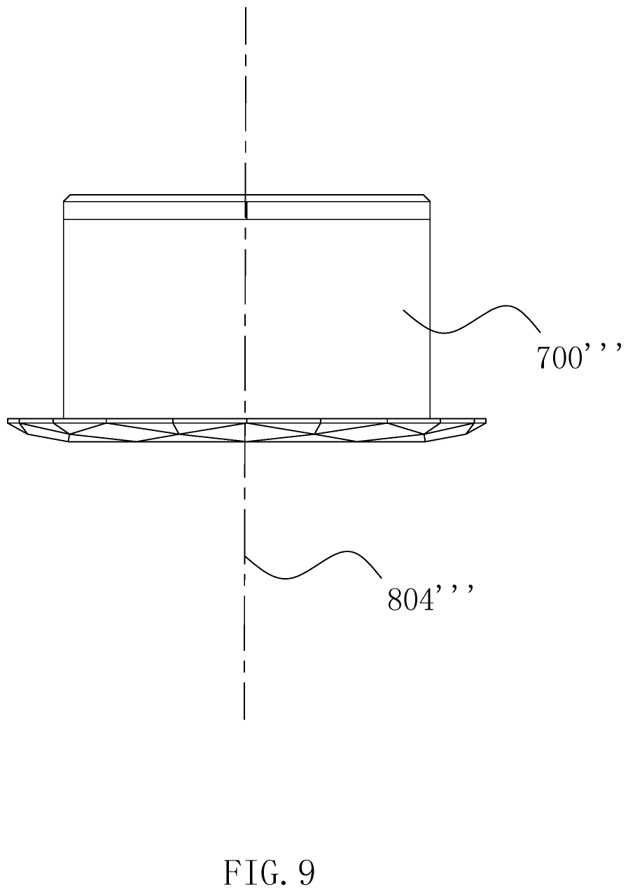

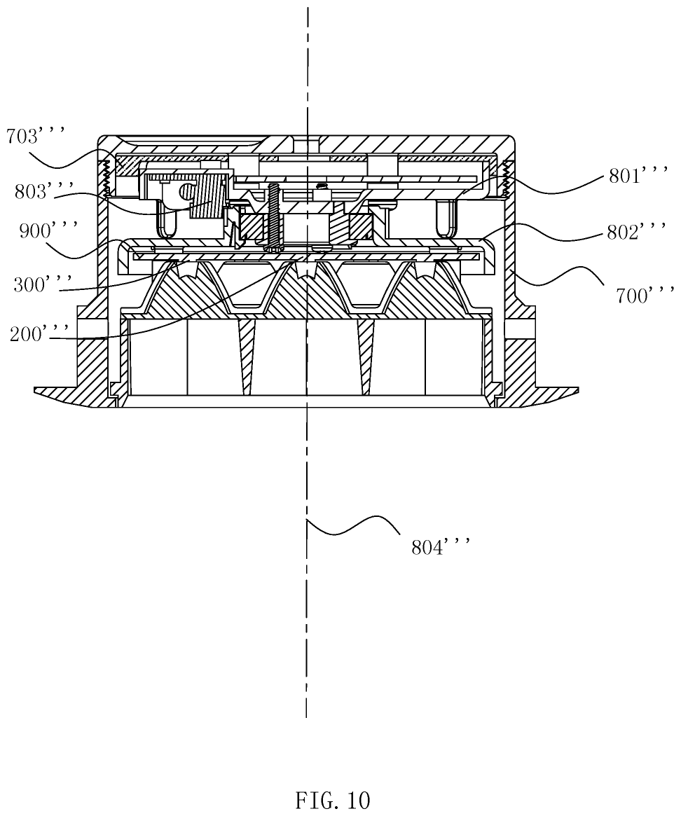

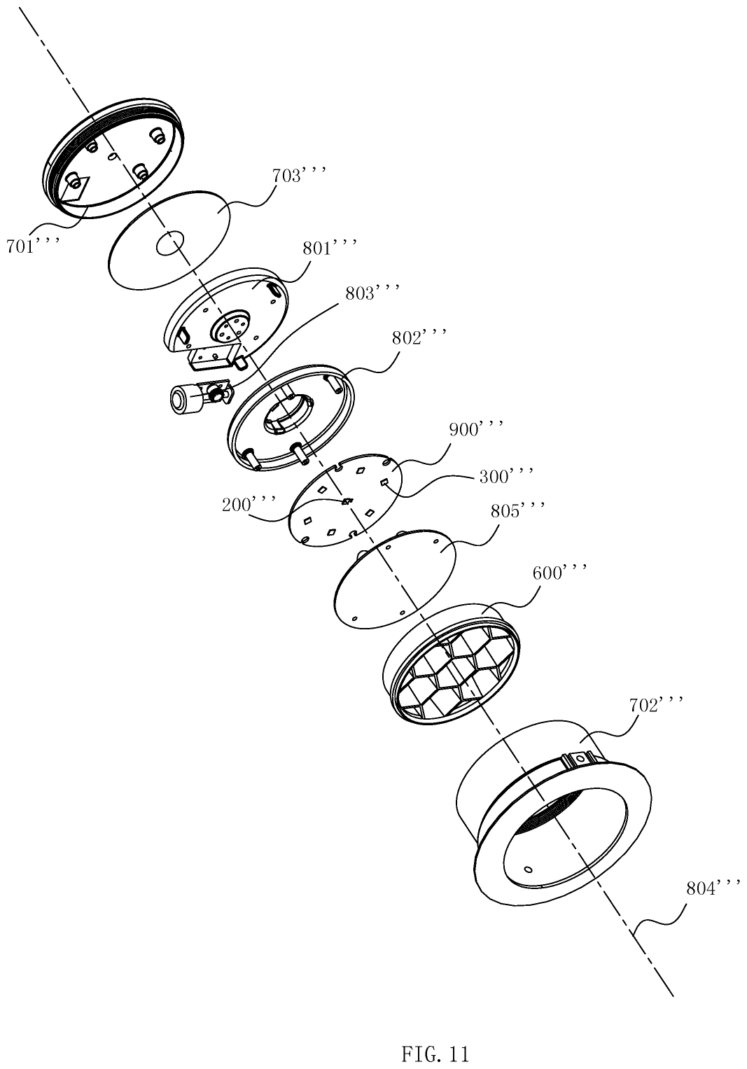

As shown in FIG. 9-11, in another embodiment, the lamp holder 700″ is cylindrical and includes a rear cover 701″ and a cylinder 702″. The movable mechanism 800″ is a rotating mechanism, which includes a fixing seat 801″, a rotating seat 802″ rotatable arranged on the fixing seat 801″, and a power source 803″ arranged on the fixing seat 801″ to drive the rotating seat 802″. The rotating seat 802″ has a center axis 804″. There are many types of power source 803″, the motor is employed in this embodiment.

The rotating seat 802″ is provided with a driving circuit board 900″ which is electrically connected with the power supply equipment. The plane where the driving circuit board 900″ is located is perpendicular to the rotation center axis 804′″, The auxiliary light source 300′″ is arranged on the driving circuit board 900″ and deviates from the rotation center axis 804″.

In the present embodiment, the main light source 200″ is arranged on the driving circuit board 900″ and the maximum light intensity direction is coincident with the rotation center axis 804″.

In order to improve the light efficiency, in the present embodiment a lens 805″ which is fixedly connected with the rotating seat 802″ is also provided. In order to achieve anti-glare effect and avoid the observation of the rotating auxiliary light source of 300″, this embodiment is also provided with an anti-glare layer 600″ which is fixedly connected with the rotating seat 802′″. The anti-glare layer 600′″ is equipped with a grid, each mesh corresponds to a light source (main light source 200″ and auxiliary light source 300″), the mesh is hexagonal, and the anti-glare layer 600″ presents a honeycomb shape with better anti-glare effect.

In order to reduce the vibration and noise brought by the rotation mechanism, the fixing seat 801′″ and the lamp holder 700′″ are separately arranged, and a shock absorbing layer 703′″ is provided between the two, and the shock absorbing layer 701′″ is made of shock absorbing materials such as silica gel.

The above are only preferred embodiments of the present embodiments, and are not used to limit the protection scope of the present embodiments. Any modification, equivalent replacement or improvement within the spirit of the present embodiments is covered by the scope of the claims of the present embodiments.

What is claimed is:

1. An illumination system, comprising a display area (100), and a main light source (200) arranged above the display area (100); a light outlet direction of the main light source (200) is directed towards the display area (100) and a first illumination surface (201) is formed on the display area (100); characterized in that, it also comprises an auxiliary light source (300) arranged above the display area (100), and a light outlet direction of the auxiliary light source (300) is toward the display area (100) and a second illumination surface (301) is formed on the display area (100), and the second illumination surface (301) moves within the first illumination surface (201) and the ratio of a luminance value of the second illumination surface (301) to a luminance value of the first illumination surface (201) is less than C, wherein C is a limit value of human eyes perceived brightness change.

2. The illumination system as claimed in claim 1 wherein the auxiliary light source (300) is provided with a plurality.

3. The illumination system as claimed in claim 2, wherein the auxiliary light source (300) is arranged around the main light source (200).

4. The illumination system as claimed in claim 1, wherein the auxiliary light source (300) is able to movable, swing or rotation.

5. The illumination system as claimed in claim 1, further comprising a mounting plate (500) arranged directly above the display area (100), and the main light source (200) and auxiliary light source (300) are arranged on the mounting plate (500).

6. The illumination system as claimed in claim 5, wherein the mounting plate (500) is provided with a moving passage (501), and the auxiliary light source (300) is arranged in the moving passage (501).

7. The illumination system as claimed in claim 6, wherein the moving passage (501) is a ring arranged about the main light source (200).

8. The illumination system as claimed in claim 5, wherein the mounting plate (500′) is provided with a lamp holder (700′), and the main light source (200) and auxiliary light source (300) are set in the same lamp holder (700′).

9. The illumination system as claimed in claim 1, further comprising an anti-glare layer (600) arranged above the display area (100), and the main light source (200) and the auxiliary light source (300) are located above the anti-glare layer (600).

10. A lamp, comprising a lamp holder (700″) and a main light source (200″) arranged in the lamp holder (700″), and a light direction of the main light source (200″) is toward the object to be irradiated and a first illumination surface (201) is formed on the display area (100) where the object is irradiated, and it further includes a movable mechanism (800″) arranged in the lamp holder (700″) and an auxiliary light source (300″) arranged on a power output end of the movable mechanism (800″), and a light outlet direction of the auxiliary light source (300″) is toward the display area (100) and a second illumination surface (301) is formed on the display area (100), and the second illumination surface (301) moves within the first illumination surface (201) and a ratio of a luminance value of the second illumination surface (301) to a luminance value of the first illumination surface (201) is less than C, wherein C is a limit value of human eyes perceived brightness change.

11. The lamp as claimed in claim 10, wherein the movable mechanism (800′″) is a rotating mechanism, which comprises a fixing seat (801′″), a rotating seat (802′″) rotatable arranged on the fixing seat (801′″), and a power source (803′″) arranged on the fixing seat (801′″) to drive the rotating seat (802′″), and the rotating seat (802′″) has a center axis (804′″).

12. The lamp as claimed in claim 11, wherein the rotating seat (802′″) is provided with a driving circuit board (900′″) which is electrically connected with power supply equipment, and a plane where the driving circuit board (900′″) is located is perpendicular to the rotation center axis (804′″), and the auxiliary light source (300′″) is arranged on the driving circuit board (900′″) and deviates from the rotation center axis (804′″).

13. The lamp as claimed in claim 10, wherein the main light source (200″) is arranged in the lamp holder (700″).

14. The lamp as claimed in claim 12, wherein the main light source (200′″) is arranged on the driving circuit board (900′″) and its maximum light intensity direction is coincident with the rotation center shaft (804′″).

15. The lamp as claimed in claim 11, wherein the fixing seat (801′″) and the lamp holder (700″) are separately arranged and a shock absorbing layer (703′″) is provided between the two.
